(19) United States
(12) Patent Application Publication
(10) Pub. No.: US 2025/0220518 A1
(43) Pub. Date: Jul. 3, 2025

(54) METHOD, DEVICE AND COMPUTER STORAGE MEDIUM OF COMMUNICATION

(71) Applicant: NEC CORPORATION, Tokyo (JP)

(72) Inventors: Da WANG, Beijing (CN); Gang WANG, Beijing (CN)

(73) Assignee: NEC CORPORATION, Tokyo (JP)

(21) Appl. No.: 18/848,303

(22) PCT Filed: Mar. 24, 2022
(86) PCT No.: PCT/CN2022/082885

§ 371 Date: Sep. 18, 2024

(51) Int. Cl. H04W 36/00; H04W 56/00; H04W 74/0833

(52) U.S. Cl. CPC H04W 36/0058; H04W 56/0045; H04W 74/0833

(57) ABSTRACT

Embodiments of the present disclosure relate to methods, devices and computer readable media for communication. A terminal device receives, from a first network device, a lower-layer signaling indicating that a data transmission is to be enabled on a cell of a second network device. If a random access procedure is determined to be skipped for the data transmission, the terminal device determines a timing advance value for a timing advance group that comprises the cell, and enables the data transmission based on the timing advance value. In this way, latency for a L1/L2 based mobility procedure may be reduced.

### TECHNICAL FIELD

Embodiments of the present disclosure generally relate to the field of telecommunication, and in particular, to methods, devices and computer storage media of communication based on a lower-layer signaling.

### BACKGROUND

When user equipment (UE) moves from a coverage area of one cell to that of another cell, a change or addition or release of a serving cell may need to be performed. Currently, the change or addition or release of the serving cell is triggered by layer 3 (L3) measurements and is done by radio resource control (RRC) signaling triggered Reconfiguration with Synchronization for change of primary cell (PCell) and primary secondary cell (PSCell). All cases involve complete layer 2 (L2) and layer 1 (L1) resets, leading to longer latency, larger overhead and longer interruption time than beam switch mobility.

Some solutions to the above issue are proposed based on a lower-layer signaling such as layer 1 (L1) or layer 2 (L2) signaling. In one solution, a data transmission is performed with a change of a serving cell upon reception of the lower-layer signaling, which is also referred to as a L1/L2 based mobility. In this way, the latency, overhead and interruption time may be reduced. Recently, it is proposed to specify mechanisms and procedures of L1/L2 based mobility for mobility latency reduction. Thus, a detailed solution about mobility latency reduction for a L1/L2 based mobility procedure needs to be further developed.

### SUMMARY

In general, embodiments of the present disclosure provide methods, devices and computer storage media of communication based on a lower-layer signaling.

In a first aspect, there is provided a method of communication. The method comprises: receiving, at a terminal device and from a first network device, a lower-layer signaling indicating that a data transmission is to be enabled on a cell of a second network device; in accordance with a determination that a random access procedure is skipped for the data transmission, determining a timing advance value for a timing advance group that comprises the cell; and enabling the data transmission based on the timing advance value.

In a second aspect, there is provided a method of communication. The method comprises: transmitting, at a first network device and to a terminal device, a lower-layer signaling indicating that a data transmission is to be enabled on a cell of a second network device; in accordance with a determination that a random access procedure is skipped for the data transmission, determining a timing advance value for a timing advance group that comprises the cell; and enabling the data transmission based on the timing advance value.

In a third aspect, there is provided a terminal device. The terminal device comprises a processor configured to perform the method according to the first aspect of the present disclosure.

In a fourth aspect, there is provided a network device. The network device comprises a processor configured to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram illustrating network protocol layer entities that may be established for a user plane (UP) protocol stack at devices according to some embodiments of the present disclosure;

FIG. 1C illustrates a schematic diagram illustrating network protocol layer entities that may be established for a control plane (CP) protocol stack at devices according to some embodiments of the present disclosure;

FIG. 1D illustrates a schematic diagram of a CU/DU architecture that may be established for a UP protocol stack at devices according to some embodiments of the present disclosure;

FIG. 1E illustrates a schematic diagram illustrating a process of L1/L2 based mobility in which some embodiments of the present disclosure can be implemented;

FIG. 2 illustrates a schematic diagram illustrating a process of communication according to embodiments of the present disclosure;

FIG. 3 illustrates an example method of communication implemented at a terminal device in accordance with some embodiments of the present disclosure;

FIG. 4 illustrates an example method of communication implemented at a network device in accordance with some embodiments of the present disclosure; and

FIG. 5 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “enable data transmission on a cell” may be interchangeably used with “a cell change or addition” or “reconfigurationWithSync for secondary cell group (SCG) or master cell group (MCG)”. The term “PSCell” refers to a SpCell of a SCG, the term “PCell” refers to a SpCell of a MCG, and the term “SpCell” refers to a primary cell of a SCG or MCG. The term “SCell” refers to a Secondary Cell. The term “L1/L2 based mobility” may be interchangeably used with “L1/L2 based mobility procedure” or “L1/L2 based inter-cell mobility”. The term “lower-layer signaling” may be interchangeably used with “L1/L2 signaling”. The term “RRC reconfiguration” may be interchangeably used with “RRC reconfiguration message”. The term “data transmission” refers to the transmitting and receiving of data.

Currently, it is proposed to specify mechanisms and procedures of L1/L2 based mobility for mobility latency reduction for the following aspects:
configuration and maintenance for multiple candidate cells to allow fast application of configurations for candidate cells;
dynamic switch mechanism among candidate serving cells (including SpCell and SCell) for the potential applicable scenarios based on L1/L2 signaling;
L1 enhancements for inter-cell beam management, including L1 measurement and reporting, and beam indication;
timing advance (TA) management;
central unit (CU)-distributed unit (DU) interface signaling to support L1/L2 mobility, if needed.

The procedure of L1/L2 based mobility may be applicable to the following scenarios:
standalone, carrier aggregation (CA) and new radio (NR)-dual connectivity (DC) case with serving cell change within one cell group (CG);
intra-DU case and intra-CU inter-DU case (applicable for Standalone and CA: no new RAN interfaces are expected);
both intra-frequency and inter-frequency;
both frequency range 1 (FR1) and frequency range 2 (FR2);
source and target cells may be synchronized or non-synchronized.

Embodiments of the present disclosure provide an improved solution of communication for L1/L2 based mobility so as to achieve mobility latency reduction. In the solution, a change to a cell (i.e., target cell) is performed based on a lower-layer signaling and data transmission on the target cell is enabled with a random access (RA) procedure skipped. In this way, communication latency may be reduced significantly.

Principles and implementations of the present disclosure will be described in detail below with reference to the figures.

### Example of Communication Network

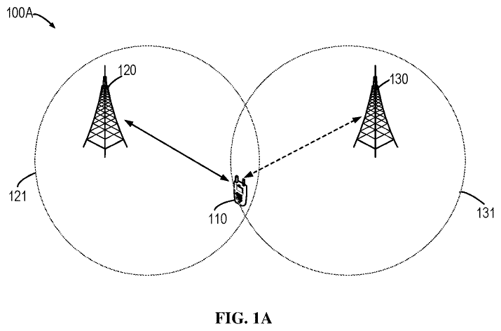

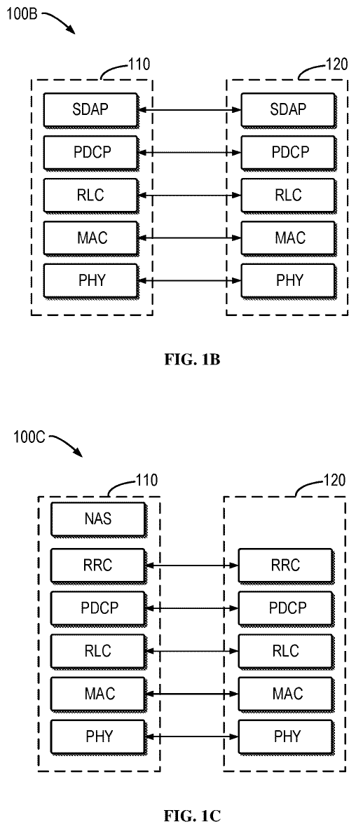

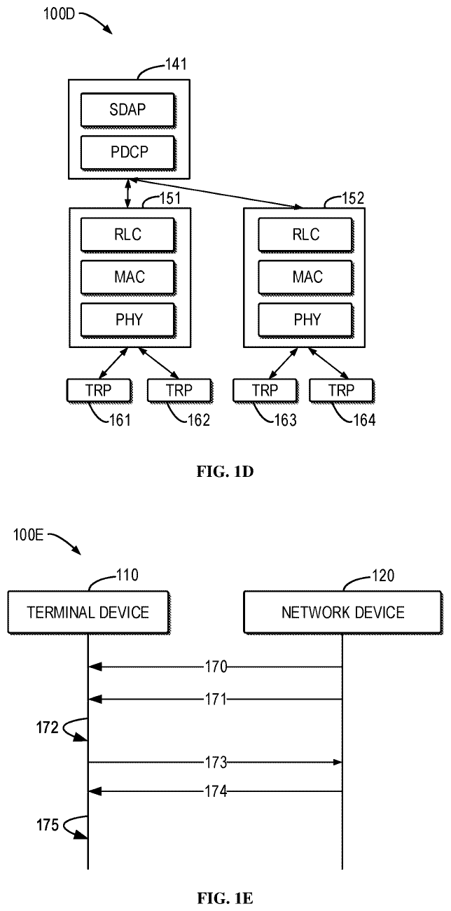

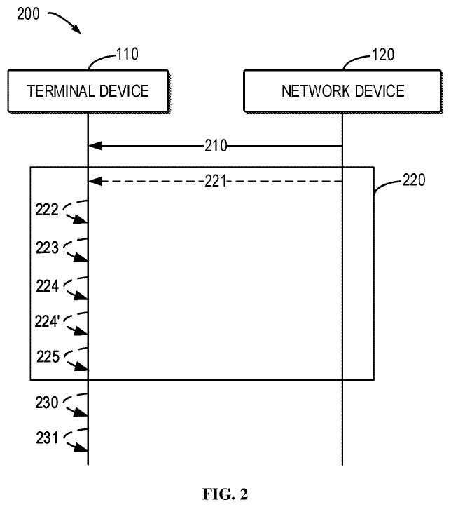

FIG. 1A illustrates a schematic diagram of an example communication network 100A in which some embodiments of the present disclosure can be implemented. As shown in FIG. 1A, the communication network 100A may include a terminal device 110 and a plurality of network devices 120 and 130 (for convenience, also referred to as a network device 120 and a network device 130 herein). The network devices 120 and 130 provide respective cells 121 and 131 to serve a terminal device.

It is to be understood that the number of devices in FIG. 1A is given for the purpose of illustration without suggesting any limitations to the present disclosure. The communication network 100A may include any suitable number of network devices and/or terminal devices adapted for implementing implementations of the present disclosure. Further, each of the network devices 120 and 130 may provide more cells for the terminal device 110.

As shown in FIG. 1A, the terminal device 110 may communicate with the network device 120 or 130 via a channel such as a wireless communication channel. The communications in the communication network 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

Communication in a direction from the terminal device 110 towards the network device 120 or 130 is referred to as UL communication, while communication in a reverse direction from the network device 120 or 130 towards the terminal device 110 is referred to as DL communication. The terminal device 110 can move amongst the cells of the network devices 120, 130 and possibly other network devices. In UL communication, the terminal device 110 may transmit UL data and control information to the network device 120 or 130 via a UL channel. In DL communication, the network device 120 or 130 may transmit DL data and control information to the terminal device 110 via a DL channel.

The communications in the communication network 100A can be performed in accordance with UP and CP protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for UP protocol stack at devices according to some embodiments of the present disclosure. For convenience, the following description is given by taking a communication between the terminal device 110 and the network device 120 as an example. It is to be understood that the following description is also suitable for the communication between the terminal device 110 and the network device 130.

In some embodiments, the network devices 120 and 130 may be different network devices. In some embodiments, the network devices 120 and 130 may be the same network device.

As shown in FIG. 1B, in the UP, each of the terminal device 110 and the network device 120 may comprise an entity for the L1 layer, i.e., an entity for a physical (PHY) layer (also referred to as a PHY entity), and one or more entities for upper layers (L2 and layer 3 (L3) layers, or upper layers) including an entity for a media access control (MAC) layer (also referred to as a MAC entity), an entity for a radio link control (RLC) layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for CP protocol stack at devices according to some embodiments of the present disclosure. As shown in FIG. 1C, in the CP, each of the terminal device 110 and the network device 120 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a radio resource control (RRC) layer (also referred to as a RRC entity). The RRC layer may be also referred to as an access stratum (AS) layer, and thus the RRC entity may be also referred to as an AS entity. As shown in FIG. 1C, the terminal device 110 may also comprise an entity for a non-access stratum (NAS) layer (also referred to as a NAS entity). An NAS layer at the network side is not located in a network device and is located in a core network (CN, not shown). In some cases, these entities are in a stack structure.

In the context of the present disclosure, L1 refers to the PHY layer, L2 refers to the MAC or RLC or PDCP or SDAP layer, and L3 refers to the RRC layer. In the context of the present disclosure, L1 or L2 may also be collectively referred to as a lower-layer, and L3 may also be referred to as a higher-layer. Accordingly, L1 or L2 signaling may be also referred to as a lower-layer signaling, and L3 signaling may be also referred to as a higher-layer signaling.

Generally, communication channels are classified into logical channels, transmission channels and physical channels. The physical channels are channels that the PHY layer actually transmits information. For example, the physical channels may comprise a physical uplink control channel (PUCCH), a physical uplink shared channel (PUSCH), a physical random-access channel (PRACH), a physical downlink control channel (PDCCH), a physical downlink shared channel (PDSCH) and a physical broadcast channel (PBCH).

The transmission channels are channels between the PHY layer and the MAC layer. For example, transmission channels may comprise a broadcast channel (BCH), a downlink shared channel (DL-SCH), a paging channel (PCH), an uplink shared channel (UL-SCH) and an random access channel (RACH).

The logical channels are channels between the MAC layer and the RLC layer. For example, the logical channels may comprise a dedicated control channel (DCCH), a common control channel (CCCH), a paging control channel (PCCH), broadcast control channel (BCCH) and dedicated traffic channel (DTCH).

Generally, channels between the RRC layer and PDCP layer are called as radio bearers. The terminal device 110 may be configured with at least one data radio bearer (DRB) for bearing data plane data and at least one signaling radio bearer (SRB) for bearing control plane data. Four types of SRBs may be defined in a RRC layer, i.e., SRB0, SRB1, SRB2 and SRB3. SRB0 uses a CCCH for RRC connection establishment or re-establishment. SRB1 uses a DCCH and is established when RRC connection is established. SRB2 uses a DCCH and is established during RRC reconfiguration and after initial security activation. SRB3 uses a DCCH and is established between the terminal device 110 and SN when a dual connection is established.

FIG. 1D illustrates a schematic diagram 100D of a CU/DU architecture that may be established for a UP protocol stack at devices according to some embodiments of the present disclosure. The CU/DU architecture may be established at a network device.

As shown in FIG. 1D, CU 141 is shown. It is to be understood that more CUs may be comprised in the UP. The CU 141 may communicate with multiple DUs. Here, two DUs 151 and 152 are shown for illustration. It is to be understood that more DUs may also be provided for implementation of embodiments of the present disclosure. As shown, CU 141 may be responsible for accomplishing the functionalities of the SDAP entity and the PDCP entity, and DU 151 or 152 may be responsible for accomplishing the functionalities of the RLC entity, the MAC entity and the PHY entity.

DU 151 may communicate with transmission and reception points (TRPs) 161 and 162. DU 152 may communicate with TRPs 163 and 164. It is to be understood that this is merely an example, and more or less TRPs are also feasible. The terminal device 110 may communicate with any of these TRPs.

In some embodiments, the terminal device 110 may switch from one TRP to another TRP under control of the same CU and same DU. For example, the terminal device 110 may be handed over from TRP 161 to TRP 162. This is called as an intra-DU serving cell change. In some embodiments, the terminal device 110 may switch from one TRP to another TRP under control of the same CU and different DUs. For example, the terminal device 110 may be handed over from TRP 162 to TRP 163. In this case, a cell change from DU 151 to DU 152 will occur. This is called as an inter-DU serving cell change. In another example, the terminal device 110 may be handed over from one TRP to another TRP under control of different CUs. In this case, a handover from a CU to another CU will occur. This is called as an inter-CU handover.

The network device 120 and the network device 130 may correspond to one or two devices under the same CU. In some embodiments, the network device 120 and the network device 130 may correspond to different TRPs under the same DU. In some embodiments, the network device 120 and the network device 130 may correspond to different TRPs under different DUs.

Return to FIG. 1A, in some embodiments, the terminal device 110 may be located within the coverage of cell 121 of the network device 120, and the terminal device 110 may communicate with the network device 120 based on network configuration. In this case, the cell 121 may be referred to as a serving cell of the terminal device 110.

In some embodiments, the terminal device 110 may establish a dual connection (i.e., simultaneous connection) with the network device 120 and the network device 130. For example, the network device 120 is a master node (MN) and the network device 130 is a secondary node (SN). In some embodiments, the terminal device 110 may communicate with the network device 120 via a set of serving cells. The set of serving cells form a MCG, and a primary cell in the MCG is called as PCell. In some scenarios, the PCell may be changed from the cell 121 to another cell. This is called as a handover. In some embodiments, the terminal device 110 may communicate with the network device 130 via another set of serving cells. The other set of serving cells form a SCG, and a primary cell in the SCG is called as PSCell. It is to be understood that the number of cells in the MCG and SCG may be any positive integer. In some scenarios, the PSCell may be changed from the cell 131 to another cell. This is called as a PScell change.

In some scenarios, the terminal device 110 may receive, from the network device 120, a L1 or L2 signaling indicating an addition or change or release of a serving cell. Upon the addition or change or release of the serving cell, the terminal device 110 may perform a data transmission with a modification or change of the serving cell. This procedure is called as the L1/L2 based mobility.

FIG. 1E illustrates a schematic diagram illustrating a process 100E of L1/L2 based mobility in which some embodiments of the present disclosure can be implemented. For the purpose of discussion, the process 100E will be described with reference to FIG. 1A. The process 100E may involve the terminal device 110 and the network device 120 as illustrated in FIG. 1A. The network device 120 may be a MN or SN serving the terminal device 110. In this example, the network device 120 provides a serving cell for the terminal device 110. The network device 130 does not provide a serving cell for the terminal device 110.

As shown in FIG. 1E, the network device 120 may transmit 170, to the terminal device 110, a RRC reconfiguration comprising a set of RRC configurations corresponding to a set of candidate cells allowing L1/L2 based mobility. The network device 120 may also transmit 171, to the terminal device 110, a configuration of beams (for example, a synchronization signal and physical broadcast channel (SSB) or a channel state information-reference signal (CSI-RS)) of a candidate cell for L1 measurement.

The terminal device 110 may perform 172 the L1 measurement based on the configuration. If a certain condition is fulfilled by a beam, e.g., quality of the beam is above threshold quality, the terminal device 110 may report 173 an indication of the beam (e.g., an identity (ID) associated with the beam) to the network device 120.

The network device 120 may transmit 174, to the terminal device 110, a L1/L2 signaling (e.g., downlink control information (DCI) or a medium access control (MAC) control element (CE)). The L1/L2 signaling indicates that transmission configuration indicator (TCI) states for a cell among candidate cells are activated along with a cell change or addition.

Upon reception of the L1/L2 signaling, the terminal device 110 may perform 175 the cell change or addition. For example, the lower layer (e.g., PHY or MAC layer) of the terminal device 110 indicates, to the RRC layer of the terminal device 110, information of the cell change or addition, e.g. an ID associated with the target cell. Upon reception of the indication, the RRC layer performs the cell change or addition by applying the RRC configuration corresponding to the target cell. The target cell may be PCell, PSCell or SCell of the terminal device 110. And the terminal device 110 may start a data transmission with the target cell using a pre-configured UE-dedicated channel and the activated TCI states.

Embodiments of the present disclosure provide an improve solution of performing a cell change or addition for L1/L2 based mobility by skipping a RA procedure. Its details will be described with reference to FIG. 2.

### Example Implementation of L1/L2 Based Mobility

FIG. 2 illustrates a schematic diagram illustrating a process 200 of communication according to embodiments of the present disclosure. For the purpose of discussion, the process 200 will be described with reference to FIG. 1A. The process 200 may involve the terminal device 110 and the network device 120 as illustrated in FIG. 1A. The network device 120 may be a MN or SN serving the terminal device 110. In this example, the network device 120 provides a serving cell for the terminal device 110. The network device 130 does not provide a serving cell for the terminal device 110.

As shown in FIG. 2, the network device 120 transmits 210, to the terminal device 110, a lower-layer signaling (i.e., L1/L2 signaling) indicating that a data transmission is to be enabled on a cell (i.e., a target cell) of the network device 130. For example, a lower-layer signaling indicating a cell change from a serving cell of network device 120 to the cell of the network device 130. As another example, a lower-layer signaling indicating an addition of the cell of the network device 130. The cell may be PCell or PSCell of the terminal device 110. In some embodiments, the lower-layer signaling may be carried in DCI. In some embodiments, the lower-layer signaling may be carried in a MAC CE. Of course, any other suitable forms are also feasible.

Upon reception of the lower-layer signaling, the terminal device 110 enables 220 the data transmission by skipping a RA procedure for the data transmission. In other words, the terminal device 110 may perform a cell change or addition by skipping a RA procedure. In some embodiments, the cell change or addition may be a PCell change or addition. In some embodiments, the cell change or addition may be a PSCell change or addition.

In some embodiments, the terminal device 110 always skips the RA procedure for L1/L2 based mobility. That is, there is no need for the network device 120 to configure the skipping of the RA procedure.

In some embodiments, the network device 120 may transmit 221 a configuration indicating whether the RA procedure is to be skipped for the data transmission. In some embodiments, the network device 120 may transmit the configuration in the lower-layer signaling. In this way, dynamic control on whether to perform a RA procedure for the L1/L2 based mobility is achieved, and communication flexibility is enhanced.

In some embodiments, the network device 120 may transmit the configuration in a RRC reconfiguration. For example, the network device 120 may transmit the configuration in the RRC reconfiguration for the candidate cells. In these embodiments, upon reception of the lower-layer signaling, the lower layer of the terminal device 110 may transmit, to the RRC layer, an indication of triggering the cell change or addition. And the RRC layer of the terminal device 110 may indicate, to the MAC layer of the terminal device 110, whether to perform the RA procedure for the target cell. In this way, a static configuration on whether to perform a RA procedure for the L1/L2 based mobility is achieved, and signaling overhead is saved. It is to be understood that the configuration may be carried by any other suitable ways.

In some embodiments, the configuration may comprise an indication indicating the skipping of the RA procedure. In this way, an explicit indication on whether to perform the RA procedure is provided. In some embodiments, the configuration may comprise TA information. In this way, an implicit indication on whether to perform the RA procedure is provided. It is to be understood that the configuration may also be carried out in any other suitable forms.

Continue to refer to FIG. 2, if the configuration indicates that the random access procedure is not to be skipped, the terminal device 110 may perform 222 the cell change or addition by triggering the RA procedure. For example, the MAC layer of the terminal device 110 may trigger the RA procedure.

If the configuration indicates that the random access procedure is to be skipped, the terminal device 110 may perform 223 the cell change or addition by skipping the RA procedure. For example, the MAC layer of the terminal device 110 may skip the RA procedure.

In some embodiments, the terminal device 110 may determine 224 a TA value for a time advance group (TAG) which contains the target cell (for convenience, also referred to as a first TAG herein) and perform the cell change or addition based on the TA value. In this case, the first TAG may be a primary timing advance group (PTAG). In some embodiments, the terminal device 110 may also determine 224′ a TA value for a timing advance group which does not contain the target cell (for convenience, also referred to as a second TAG herein). In this case, the second TAG may be a secondary timing advance group (STAG). In some embodiments, the terminal device 110 may determine one or more TA values for a set of second TAGs. The number of second TAGs in the set of second TAGs may be 1, 2, 3 or any other suitable numbers.

In the context of the present disclosure, a TAG comprising a SpCell of a MAC entity is referred to as a PTAG, and a TAG other than the PTAG is referred to as a STAG.

Example Implementation of Determination of TA with RA Procedure Skipped

Traditionally, if the RA procedure is not performed for L1/L2 based mobility, a TA value would be maintained. However, a TA value of a time advance group (TAG) of the target cell may be different from the maintained TA value. Then how to determine a TA value to be used for the target cell becomes an issue.

Embodiments of the present disclosure provide solutions for determining the TA value to be used for the target cell. These solutions will be described in connection with Embodiments 1 to 5.

### Embodiment 1

In this embodiment, a TA value maintained for a TAG (for convenience, also referred to as a further TAG or an existing TAG herein) of MN or SN of the terminal device 110 is reused for the first TAG or second TAG.

In some embodiments, the existing TAG may be the first TAG. That is, a TA value of the first TAG is maintained. In some embodiments, the existing TAG may be a TAG different from the first TAG. That is, a TA value of a TAG different from the first TAG is reused for the first TAG.

In some embodiments, the terminal device 110 may receive, from the network device 110, an indication that a TA value of an existing TCG is to be used for the first TAG. For example, the indication may be an identity (ID) of the existing TAG, and the terminal device 110 may reuse the TA value of the existing TAG associated with the ID for the first TAG. In some embodiments, the indication may be carried in the lower-layer signaling. In some embodiments, the indication may be carried in the RRC reconfiguration, for example in the RRC reconfiguration for the candidate cells.

In some embodiments, the existing TAG may be the second TAG. That is, a TA value of the second TAG is maintained. In some embodiments, the existing TAG may be a TAG different from the second TAG. That is, a TA value of a TAG different from the second TAG is reused for the second TAG.

In some embodiments, the terminal device 110 may receive from the network device 120 an indication of a TA value of an existing TCG to be used for a second TAG. For example, the indication may be an ID of the existing TAG and an ID of the second TAG, the terminal device 110 may apply the TA value of the existing TAG for the second TAG. In some embodiments, the indication may be carried in the lower-layer signaling. In some embodiments, the indication may be carried in the RRC reconfiguration, for example in the RRC reconfiguration for the candidate cells.

In some embodiments, for the case that the configuration indicating that a TA value of an existing TCG is reused for first TAG or second TAG is included in the RRC reconfiguration (e.g. RRC reconfiguration for the candidate cell), the RRC layer of the terminal device 110 may receive, from the MAC layer of the terminal device 110, an indication of the triggering of L1/L2 based mobility, and indicate configuration to the lower layer (e.g. MAC layer or PHY layer).

In some embodiments, after applying the determined TA value for the first TAG, the terminal device 110 may start or restart a timer for time alignment for the first TAG. In some embodiments, after applying the determined TA value for the second TAG, the terminal device 110 may start or restart a timer for time alignment for the second TAG.

By configuring TA information in L1/L2 signaling, dynamic control of TA for the target cell may be achieved. The TA information of each time of handover to the same candidate cell may be different. While for configuring the TA information in RRC Reconfiguration, a static configuration of TA may be achieved and thus signaling overhead may be saved.

### Embodiment 2

In this embodiment, zero is used as the TA value of the first TAG or second TAG.

In some embodiments, the terminal device 110 may receive, from the network device 120, an indication that zero is used as the TA value of the first TAG. In these embodiments, the terminal device 110 may use zero as the TA value of the first TAG after reception of the indication. In some embodiments, the indication may be carried in the lower-layer signaling. In some embodiments, the indication may be carried in the RRC reconfiguration, for example in the RRC reconfiguration for the candidate cells.

In some embodiments, the terminal device 110 may receive, from the network device 120, an indication that zero is used as a TA value to be used for a second TAG. In these embodiments, the terminal device 110 may use zero as the TA value for the second TAG after reception of the indication. In some embodiments, the indication may be carried in the lower-layer signaling. In some embodiments, the indication may be carried in the RRC reconfiguration, for example in the RRC reconfiguration for the candidate cells.

In some embodiments, for the case indication that zero is used as TA value for the first TAG or second TAG is included the RRC reconfiguration (e.g. RRC reconfiguration for the candidate cell), the RRC layer of the terminal device 110 may receive, from the MAC layer of the terminal device 110, an indication of the triggering of L1/L2 based mobility, and indicate zero is used for the TA value to the MAC layer.

In some embodiments, after applying the determined TA value (i.e. zero) for the first TAG, the terminal device 110 may start or restart a timer for time alignment for the first TAG. In some embodiments, after applying the determined TA value (i.e. zero) for the second TAG, the terminal device 110 may start or restart a timer for time alignment for the second TAG.

By configuring TA information in L1/L2 signaling, dynamic control of TA for the target cell may be achieved. The TA information of each time of handover to the same candidate cell may be different. While for configuring the TA information in RRC Reconfiguration, a static configuration of TA may be achieved and thus signaling overhead may be saved.

### Embodiment 3

In this embodiment, the terminal device 110 determines the TA value of the first TAG based on at least one of an absolute value or an adjustment value for the TA value. In these embodiments, the at least one of the absolute value or the adjustment value is configured in the lower-layer signaling. In these embodiments, the at least one of the absolute value or the adjustment value is configured in the RRC reconfiguration, for example in the RRC reconfiguration for the candidate cells. In other words, the TA value of the first TAG is configured by the network device 120.

In some embodiments, the absolute value may be 12 bits. In some embodiments, the adjustment value may be 8 bits.

In some embodiments where the absolute value is configured, the terminal device 110 may use the absolute value as the TA value of the first TAG. In some embodiments where the adjustment value is configured, the terminal device 110 may determine the TA value of the first TAG by adjusting a TA value of the first TAG based on the adjustment value.

In some embodiment, the terminal device 110 may determine the TA value of the second TAG based on at least one of an absolute value or an adjustment value for the TA value. In some embodiment, the at least one of the absolute value or the adjustment value may be configured in the lower-layer signaling. In some embodiment, the at least one of the absolute value or the adjustment value may be configured in the RRC reconfiguration, for example in the RRC reconfiguration for the candidate cells. In other words, the TA value of the second TAG is configured by the network device 120.

In some embodiments where the absolute value is configured for the second TAG, the terminal device 110 may use the absolute value as the TA value of the second TAG. In some embodiments where the adjustment value is configured, the terminal device 110 may determine the TA value of the second TAG by adjusting a TA value of the second TAG based on the adjustment value.

In some embodiments, for the case that the configuration of TA value of for first TAG or second TAG is included in the RRC reconfiguration (e.g. RRC reconfiguration for the candidate cell), the RRC layer of the terminal device 110 may receive, from the MAC layer of the terminal device 110, an indication of the triggering of L1/L2 based mobility, and indicate, to the lower layer (e.g. MAC layer or PHY layer), at least one of an absolute value or an adjustment value for a TA value.

In some embodiments, after applying the determined TA value for the first TAG, the terminal device 110 may start or restart a timer for time alignment for the first TAG associated with the target cell. In some embodiments, after applying the determined TA value (i.e. zero) for the first TAG, the terminal device 110 may start or restart a timer for time alignment for the second TAG.

By configuring TA information in L1/L2 signaling, dynamic control of TA for the target cell may be achieved. The TA information of each time of handover to the same candidate cell may be different. While for configuring the TA information in RRC Reconfiguration, a static configuration of TA may be achieved and thus signaling overhead may be saved.

### Embodiment 4

In this embodiment, the terminal device 110 may calculate the TA value of the first TAG.

In some embodiments, the terminal device 110 may measure a propagation delay of the target cell based on a beam configured for L1 measurement or a beam associated with a TCI state in the lower-layer signaling. The terminal device 110 may calculate the TA value of the first TAG based on the measured propagation delay.

In some embodiments, the terminal device 110 may receive, from the network device 120, an indication indicating whether the TA value of the first TAG is calculated by the terminal device 110. In some embodiments, the indication may be carried in the lower-layer signaling. In some embodiments, the indication may be carried in the RRC reconfiguration.

In some embodiments, for the case that indication is included in RRC reconfiguration (e.g. RRC reconfiguration for the candidate cell), the RRC layer of the terminal device 110 may receive, from the MAC layer of the terminal device 110, an indication of the triggering of L1/L2 based mobility, and indicate the lower layer (e.g. MAC layer or PHY layer) to perform TA calculation.

If the indication indicates that the TA value of the first TAG is calculated by the terminal device 110, the terminal device 110 may calculate the TA value of the first TAG. For example, the terminal device 110 may calculate the TA value by equation (1) below.

$${V}_{T} = {V}_{S} - 2 * ( T 1 - T 2 ) \qquad ( 1 )$$

where V_{T} denotes a TA value for a TAG associated with a target cell, V_{S} denotes a TA value for a TAG associated with a source cell, T1 denotes a propagation delay from the source cell to UE (i.e., the terminal device 110), and T2 denotes a propagation delay from the target cell to UE (i.e., the terminal device 110).

It is to be understood that equation (1) is merely an example, and any other suitable ways are also feasible for calculation of the TA value of the first TAG.

In some embodiments, after applying the calculated TA value for the first TAG, the terminal device 110 may start or restart a timer for time alignment for the first TAG.

By configuring TA information in L1/L2 signaling, dynamic control of TA for the target cell may be achieved. The TA information of each time of handover to the same candidate cell may be different. While for configuring the TA information in RRC Reconfiguration, a static configuration of TA may be achieved and thus signaling overhead may be saved.

### Embodiment 5

In this embodiment, the terminal device 110 determines the TA value of the first from a set of TA values. The set of TA values is predefined or preconfigured. For example, the set of TA values is configured in the RRC reconfiguration. Each TA value in the set of TA values is associated with one index.

In some embodiments, the terminal device 110 may receive an indication indicating an index of the TA value of the first TAG in the set of TA values, and determine the TA value of the first TAG from the set of TA values based on the index of the TA value of the first TAG. In some embodiments, the indication may be carried in the lower-layer signaling. In some embodiments, the indication may be carried in the RRC reconfiguration, for example the RRC reconfiguration for the candidate cells.

In some embodiments, the terminal device 110 may receive an indication indicating an index of a TA value to be used for a second TAG. In these embodiments, the terminal device 110 may determine the TA value of the second TAG from the set of TA values base on the index of the TA value to be used for the second TAG. In some embodiments, the indication may be carried in the lower-layer signaling. In some embodiments, the indication may be carried in the RRC reconfiguration, for example in the RRC reconfiguration for the candidate cells.

In some embodiments, for case that indication is included in the RRC reconfiguration, the RRC layer of the terminal device 110 may receive, from the MAC layer of the terminal device 110, an indication of the triggering of L1/L2 based mobility, and indicate an index of a TA value to the lower layer (e.g. MAC layer or PHY layer).

In some embodiments, after applying the calculated TA value for the first TAG, the terminal device 110 may start or restart a timer for time alignment for the first TAG associated with the target cell. In some embodiments, after applying the calculated TA value for the second TAG, the terminal device 110 may start or restart a timer for time alignment for the second TAG.

By configuring TA information in L1/L2 signaling, dynamic control of TA for the target cell may be achieved. The TA information of each time of handover to the same candidate cell may be different. While for configuring the TA information in RRC Reconfiguration, a static configuration of TA may be achieved and thus signaling overhead may be saved.

So far, a terminal device may determine or update a TA value of a target cell when the RA procedure is not performed for the L1/L2 based mobility.

### Example Implementation of Determination of Initial UL Grant

Continue to refer to FIG. 2, the terminal device 110 may determine 225 an UL grant for an initial UL transmission to the target cell, and perform the initial UL transmission based on the UL grant.

Traditionally, a terminal device may obtain initial scheduling of an UL grant from a target cell to transmit RRCReconfigurationComplete message by initiating a RA procedure. However, if a RA procedure is skipped for L1/L2 based mobility, one issue is how to obtain the initial UL grant to transmit the RRCReconfigurationComplete message. In view of this, embodiments of the present disclosure provide a solution of determining an UL grant for an initial UL transmission for L1/L2 based mobility.

In some embodiments, the network device 120 may transmit, in the lower-layer signaling, an UL grant for an initial UL transmission to the target cell. In some embodiments, the network device 120 may transmit, in the RRC reconfiguration, an UL grant for an initial UL transmission to the target cell.

Upon reception of the UL grant, the terminal device 110 may perform the initial UL transmission. For example, the terminal device 110 may transmit a RRC Reconfiguration Complete message to the target cell based on the UL grant. Of course, any other suitable initial UL transmissions are also feasible.

In this way, a terminal device may obtain the UL grant for initial UL transmission as soon as possible. Thus, a latency of data for the L1/L2 based mobility may be reduced. Further, since a terminal device moves back and forth among the candidate cells, using a L1/L2 signaling is a flexible way to provide initial UL grant compared with using a RRC message. In addition, using a L1/L2 signaling is more suitable for an intra DU scenario.

### Example Implementation of Determination of Successful Completion of Cell Change or Addition

Traditionally, when a cell change or addition procedure is triggered, a timer (for example, T304) for reconfiguration with sync failure detection may be started. When the RRC layer receives an indication of successful completion of a RA procedure, the RRC layer considers the successful completion of the cell change or addition procedure, and stops the timer. However, if a RA procedure is skipped, the RRC layer cannot know the successful completion of the cell change or addition procedure, and the timer may always run. In view of this, embodiments of the present disclosure provide a solution so as to overcome the above or other potential issues.

Continue to refer to FIG. 2, the terminal device 110 may determine 230 whether an upper layer (for example, RRC layer) of the terminal device 110 receives, from a lower layer (for example, MAC layer) of the terminal device 110, an indication indicating a successful reception of a PDCCH transmission addressed to a cell-radio network temporary identifier (C-RNTI). If the upper layer receives the indication, the terminal device 110 may stop 231 a timer (e.g., T304) for reconfiguration with sync failure detection.

In other words, if the RA procedure is not performed for L1/L2 based mobility, the MAC layer indicates the successful reception of a PDCCH transmission addressed to C-RNTI to the RRC layer. Upon reception from the MAC layer of the indication indicating the successful reception of the PDCCH transmission addressed to the C-RNTI, the RRC layer considers successful completion of the cell change or addition, and stops the timer T304.

In some alternative embodiments, if the RA procedure is skipped for L1/L2 based mobility, the terminal device 110 may not start (i.e., disable) the timer configured for reconfiguration with sync failure detection. In other words, if random access is not skipped for reconfiguration with sync, the terminal device 110 may start the timer for the corresponding SpCell.

In this way, a cell change or addition procedure based on L1/L2 based mobility may be successfully completed without performing a RA procedure.

### Example Implementation of Methods

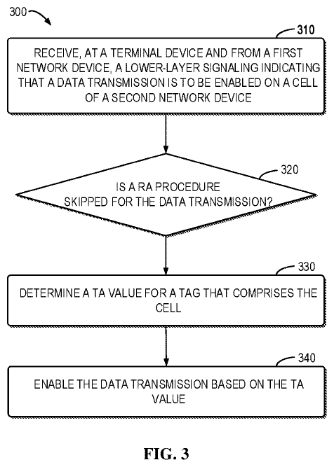

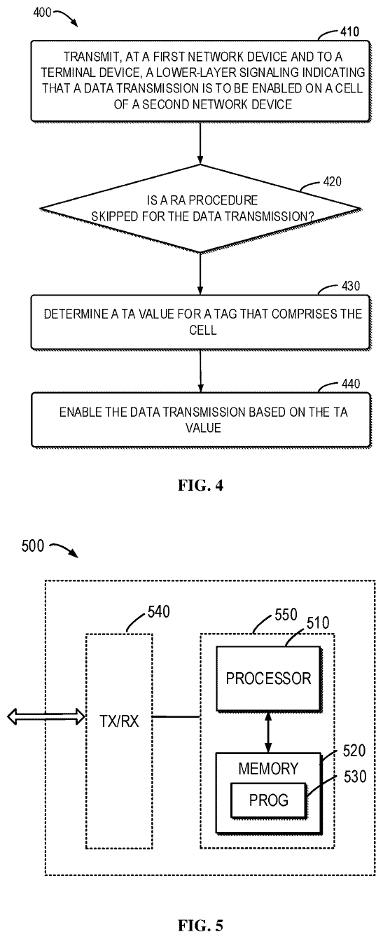

Accordingly, embodiments of the present disclosure provide methods of communication implemented at a terminal device and a network device. These methods will be described below with reference to FIGS. 3 to 4.

FIG. 3 illustrates an example method 300 of communication implemented at a terminal device in accordance with some embodiments of the present disclosure. For example, the method 300 may be performed at the terminal device 110 as shown in FIG. 1A. For the purpose of discussion, in the following, the method 300 will be described with reference to FIG. 1A. It is to be understood that the method 300 may include additional blocks not shown and/or may omit some blocks as shown, and the scope of the present disclosure is not limited in this regard. Assuming that the network device 120 may be a MN or SN serving the terminal device 110. The network device 120 provides a serving cell (for example, the cell 121) for the terminal device 110. The network device 130 does not provide a serving cell for the terminal device 110.

At block 310, the terminal device 110 receives, from a first network device (for example, the network device 120), a lower-layer signaling indicating that a data transmission is to be enabled on a cell (for example, the cell 131) of a second network device (for example, the network device 130).

At block 320, the terminal device 110 determines whether a RA procedure is skipped for the data transmission. If the RA procedure is skipped for the data transmission, the method 300 proceeds to block 330.

At block 330, the terminal device 110 determines a TA value for a TAG that comprises the cell (i.e. the first TAG).

At block 340, the terminal device 110 enables, based on the TA value, the data transmission by skipping a RA procedure for the data transmission.

In some embodiments, the terminal device 110 may receive, from the network device 120, a configuration indicating whether the RA procedure is to be skipped for the data transmission. In some embodiments, the terminal device 110 may receive the configuration in the lower-layer signaling or in a RRC reconfiguration. If the RA procedure is to be skipped, the terminal device 110 may enable the data transmission by skipping the RA procedure.

In some embodiments, if an indication indicating the skipping of the RA procedure is comprised in in the lower-layer signaling or the RRC reconfiguration, the terminal device 110 may determine that the skipping of the RA procedure is configured. In some embodiments, if TA information is comprised in in the lower-layer signaling or the RRC reconfiguration, determining that the skipping of the RA procedure is configured.

In some embodiments, the terminal device 110 may further start or restart a timer for time alignment for the first TAG.

In some embodiments, the terminal device 110 may further determine a TA value for a TAG that does not comprises the cell (i.e., the second TAG). In some embodiments, the terminal device 110 may further start or restart a timer for time alignment for the second TAG.

In some embodiments for the TA value of the first TAG or the second TAG, the terminal device 110 may reuse, as the TA value, a further timing advance value maintained for a further timing advance group. In some embodiments, if the lower-layer signaling or a RRC reconfiguration comprises an ID of the further TAG, the terminal device 110 may reuse the further TA value of the further TAG associated with the ID.

In some embodiments for the TA value of the first TAG or the second TAG, the terminal device 110 may use zero as the TA value. In some embodiments, if the lower-layer signaling or a RRC reconfiguration indicates that zero is used as the TA value, the terminal device 110 may use zero as the TA value.

In some embodiments for the TA value of the first TAG or the second TAG, the terminal device 110 may determine the TA value based on at least one of an absolute value or an adjustment value for the TA value configured in the lower-layer signaling or a RRC reconfiguration.

In some embodiments for the TA value of the first TAG, the terminal device 110 may measure a propagation delay of the cell based on a beam configured for L1 measurement or a beam associated with a TCI state in the lower-layer signaling, and calculate the TA value based on the measured propagation delay. In some embodiments, the terminal device 110 may receive, from the network device 120, the lower-layer signaling or a RRC reconfiguration indicating whether the TA value is calculated by the terminal device 110. If the TA value is calculated by the terminal device 110, the terminal device 110 may calculate the TA value.

In some embodiments for the TA value of the first TAG or the second TAG, the terminal device 110 may determine the TA value from a set of TA values based on an index of the TA value indicated in the lower-layer signaling or a RRC reconfiguration.

In some embodiments, the terminal device 110 may determine, from the lower-layer signaling or a RRC reconfiguration, an UL grant for an initial UL transmission to the cell, and perform, based on the UL grant, the initial UL transmission to the cell.

In some embodiments, the terminal device 110 may start a timer for reconfiguration with sync failure detection in response to enabling the data transmission, and stop, by an upper layer of the terminal device 110, the timer for reconfiguration with sync detection in response to receiving, from a lower layer of the terminal device 110, an indication indicating a successful reception of a PDCCH transmission addressed to a C-RNTI. In some embodiments, the terminal device 110 may not start the timer for reconfiguration with sync detection in response to the skipping of the RA procedure.

With the method 300, a L1/L2 based mobility procedure is achieved by skipping a RA procedure.

FIG. 4 illustrates an example method 400 of communication implemented at a network device in accordance with some embodiments of the present disclosure. For example, the method 400 may be performed at the network device 120 or 130 as shown in FIG. 1A. For the purpose of discussion, in the following, the method 400 will be described with reference to FIG. 1A. It is to be understood that the method 400 may include additional blocks not shown and/or may omit some blocks as shown, and the scope of the present disclosure is not limited in this regard. Assuming that the network device 120 may be a MN or SN serving the terminal device 110. The network device 120 provides a serving cell (for example, the cell 121) for the terminal device 110. The network device 130 does not provide a serving cell for the terminal device 110.

As shown in FIG. 4, at block 410, a first network device (for example, the network device 120) transmits, to the terminal device 110, a lower-layer signaling indicating that a data transmission is to be enabled on a cell of a second network device (for example, the network device 130).

At block 420, the network device 120 determines whether a RA procedure is skipped for the data transmission. If the RA procedure is skipped for the data transmission, the method 400 proceeds to block 430.

At block 430, the network device 120 determines a TA value for a TAG that comprises the cell (i.e. the first TAG). The determination of the TA value is similar as that done at the terminal device 110, and thus is omitted here for concise.

At block 440, the network device 120 enables, based on the TA value, the data transmission without a RA procedure for the data transmission.

In some embodiments, the network device 120 may transmit, to the terminal device 110, a configuration indicating whether the RA procedure is to be skipped for the data transmission. In some embodiments, the network device 120 may transmit the configuration in the lower-layer signaling or in a RRC reconfiguration.

In some embodiments, the configuration may comprise at least one of: an indication indicating the skipping of the random access procedure, or TA information.

In some embodiments, the network device 120 may transmit, to the terminal device 110, information indicating at least one of the following: zero being used as the TA value for the first TAG; zero being used as a TA value for a TAG that does not comprise the cell (i.e., the second TAG); at least one of an absolute value or an adjustment value for the TA value for the first TAG; at least one of an absolute value or an adjustment value to be used for the second TAG; whether the TA value for the first TAG is calculated by the terminal device 110; an ID of a further TAG configured to the terminal device 110; an ID of a TAG configured as the second TAG; an index of the TA value in a set of TA values to be used for a cell group associated with the cell; an index of a TA value to be used for the second TAG; or an UL grant for an initial UL transmission to the cell.

In some embodiments, the network device 120 may transmit the information in the lower-layer signaling or in a RRC reconfiguration.

With the method 400, a L1/L2 based mobility procedure without a RA procedure is enabled.

It is to be understood that the operations of methods 300 and 400 are similar as that described in connection with FIG. 2, and thus other details are not repeated here for concise.

### Example Implementation of Devices and Apparatuses

FIG. 5 is a simplified block diagram of a device 500 that is suitable for implementing embodiments of the present disclosure. The device 500 can be considered as a further example implementation of the terminal device 110 or the network device 120 or the network device 130 as shown in FIG. 1A. Accordingly, the device 500 can be implemented at or as at least a part of the terminal device 110 or the network device 120 or the network device 130.

As shown, the device 500 includes a processor 510, a memory 520 coupled to the processor 510, a suitable transmitter (TX) and receiver (RX) 540 coupled to the processor 510, and a communication interface coupled to the TX/RX 540. The memory 510 stores at least a part of a program 530. The TX/RX 540 is for bidirectional communications. The TX/RX 540 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 530 is assumed to include program instructions that, when executed by the associated processor 510, enable the device 500 to operate in accordance with the embodiments of the present disclosure, as discussed herein with reference to FIGS. 1A to 4. The embodiments herein may be implemented by computer software executable by the processor 510 of the device 500, or by hardware, or by a combination of software and hardware. The processor 510 may be configured to implement various embodiments of the present disclosure. Furthermore, a combination of the processor 510 and memory 520 may form processing means 550 adapted to implement various embodiments of the present disclosure.

The memory 520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 520 is shown in the device 500, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

In some embodiments, a terminal device comprises circuitry configured to: receive, from a first network device, a lower-layer signaling indicating that a data transmission is to be enabled on a cell of a second network device; in accordance with a determination that a random access procedure is skipped for the data transmission, determine a timing advance value for a timing advance group that comprises the cell; and enable the data transmission based on the timing advance value.

In some embodiments, the circuitry may be further configured to: receive, from the first network device, a configuration indicating whether the random access procedure is to be skipped for the data transmission; and in accordance with a determination that the random access procedure is to be skipped, determine that the random access procedure is skipped for the data transmission.

In some embodiments, the circuitry may be configured to receive the configuration by: receiving the configuration in the lower-layer signaling or in a radio resource control reconfiguration.

In some embodiments, the circuitry may be further configured to: in accordance with a determination that an indication indicating the skipping of the random access procedure is comprised in in the lower-layer signaling or the radio resource control reconfiguration, determine that the skipping of the random access procedure is configured; or in accordance with a determination that timing advance information is comprised in in the lower-layer signaling or the radio resource control reconfiguration, determine that the skipping of the random access procedure is configured.

In some embodiments, the circuitry may be further configured to determine a timing advance value for a timing advance group that does not comprise the cell.

In some embodiments, the circuitry may be configured to determine the timing advance value by: reusing, as the timing advance value, a further timing advance value maintained for a further timing advance group.

In some embodiments, the circuitry may be configured to reuse the further timing advance value by: in accordance with a determination that the lower-layer signaling or a radio resource control reconfiguration comprises an identity of the further timing advance group, reusing the further timing advance value of the further timing advance group associated with the identity.

In some embodiments, the circuitry may be configured to determine the timing advance value by using zero as the timing advance value.

In some embodiments, the circuitry may be configured to use zero as the timing advance value by: in accordance with a determination that the lower-layer signaling or a radio resource control reconfiguration indicates that zero is used as the timing advance value, using zero as the timing advance value.

In some embodiments, the circuitry may be configured to determine the timing advance value by: determining the timing advance value based on at least one of an absolute value or an adjustment value for the timing advance value configured in the lower-layer signaling or a radio resource control reconfiguration.

In some embodiments, the circuitry may be configured to determine the timing advance value by: measuring a propagation delay of the cell based on a beam configured for L1 measurement or a beam associated with a transmission configuration indicator state in the lower-layer signaling; and calculating the timing advance value based on the measured propagation delay.

In some embodiments, the circuitry may be configured to calculate the timing advance value by: receiving, from the first network device, the lower-layer signaling or a radio resource control reconfiguration indicating whether the timing advance value is calculated by the terminal device; and in accordance with a determination that the timing advance value is calculated by the terminal device, calculating the timing advance value.

In some embodiments, the circuitry may be configured to determine the timing advance value by: determining the timing advance value from a set of timing advance values based on an index of the timing advance value indicated in the lower-layer signaling or a radio resource control reconfiguration.

In some embodiments, the circuitry may be further configured to start or restart a timer for time alignment for the timing advance group that comprises the cell.

In some embodiments, the circuitry may be further configured to start or restart a timer for time alignment for the timing advance group that does not comprise the cell.

In some embodiments, the circuitry may be configured to enable the data transmission by: determining, from the lower-layer signaling or a radio resource control reconfiguration, an uplink grant for an initial uplink transmission to the cell; and performing, based on the uplink grant, the initial uplink transmission to the cell.

In some embodiments, the circuitry may be further configured to: start a timer for reconfiguration with sync failure detection in response to enabling the data transmission; and stop, by an upper layer of the terminal device, the timer for reconfiguration with sync failure detection in response to receiving, from a lower layer of the terminal device, an indication indicating a successful reception of a physical downlink control channel transmission addressed to a cell-radio network temporary identifier.

In some embodiments, the circuitry may be further configured to: in response to the skipping of the random access procedure, disabling a timer for reconfiguration with sync failure detection.

In some embodiments, a network device comprise a circuitry configured to: transmit, at a first network device and to a terminal device, a lower-layer signaling indicating that a data transmission is to be enabled on a cell of a second network device; in accordance with a determination that a random access procedure is skipped for the data transmission, determine a timing advance value for a timing advance group that comprises the cell; and enable the data transmission based on the timing advance value.

In some embodiments, the circuitry may be further configured to transmit, to the terminal device, a configuration indicating whether the random access procedure is to be skipped for the data transmission. In some embodiments, the circuitry may be configured to transmit the configuration by: transmitting the configuration in the lower-layer signaling or in a radio resource control reconfiguration.

In some embodiments, the configuration may comprise at least one of: an indication indicating the skipping of the random access procedure, or timing advance information.

In some embodiments, the circuitry may be further configured to transmit, to the terminal device, information indicating at least one of the following: zero being used as the timing advance value for the timing advance group that comprises the cell; zero being used as a timing advance value for a timing advance group that does not comprise the cell; at least one of an absolute value or an adjustment value for the timing advance value for the timing advance group that comprises the cell; at least one of an absolute value or an adjustment value to be used for a timing advance group that does not comprise the cell; whether the timing advance value for the timing advance group that comprises the cell is calculated by the terminal device; an identity of a further timing advance group configured to the terminal device; an identity of a timing advance group configured as a timing advance group that does not comprise the cell; an index of the timing advance value in a set of timing advance values to be used for a cell group associated with the cell; an index of a timing advance value to be used for a timing advance group that does not comprise the cell; or an uplink grant for an initial uplink transmission to the cell.

In some embodiments, the circuitry may be configured to transmit the information by: transmitting the information in the lower-layer signaling or in a radio resource control reconfiguration.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 4. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-26. (canceled)

27. A method of a User Equipment (UE), the method comprising:
receiving, from a network, a cell switch command signalled via a Medium Access Control (MAC) Control Element (CE) on a serving cell; and
considering a cell switch procedure to be ongoing in a case where the UE receives the MAC CE, wherein the cell switch procedure is that the network triggers via the MAC CE based on a Layer 1 (L1) measurement, and wherein the cell switch procedure is where the UE skips a Random Access procedure.

28. The method according to claim 27,
wherein the MAC CE includes information related to a Timing Advance (TA).

29. The method according to claim 28,
wherein the information indicates that the UE can skip the Random Access procedure for the cell switch procedure.

30. The method according to claim 28,
wherein the information indicates an index value used to control an amount of a time alignment.

31. The method according to claim 30, further comprising:
applying the information for a Primary Timing Advance Group (PTAG); and
starting or restarting a timer for the time alignment, wherein the timer is associated with the PTAG.

32. The method according to claim 27, further comprising:
receiving, from the network, a Radio Resource Control (RRC) Reconfiguration message, wherein the RRC Reconfiguration message includes a candidate configuration for the cell switch procedure.

33. The method according to claim 32, further comprising:
estimating a Timing Advance based on the candidate configuration.

34. The method according to claim 33, further comprising:
applying the Timing Advance for a Primary Timing Advance Group (PTAG); and
starting or restarting a timer for a time alignment, wherein the timer is associated with the PTAG.

35. The method according to claim 32, further comprising:
accessing a target cell using an uplink grant which is provided in the candidate configuration.

36. The method according to claim 27, further comprising:
considering the cell switch procedure to be successfully completed in a case where a Physical Downlink Control Channel (PDCCH) for a Cell Radio Network Temporary Identifier (C-RNTI) is received and the cell switch procedure is ongoing.

37. The method according to claim 27, further comprising:
indicating an upper layer that the cell switch procedure has been successfully completed in a case where a Physical Downlink Control Channel (PDCCH) for a Cell Radio Network Temporary Identifier (C-RNTI) is received and the cell switch procedure is ongoing.

38. The method according to claim 37, further comprising:
stopping a timer T304 in a case where an indication from a lower layer of successful completion of the cell switch procedure is received.

39. A method of a Radio Access Network (RAN) node, the method comprising:
sending, to a User Equipment (UE), a cell switch command signalled via a Medium Access Control (MAC) Control Element (CE) on a serving cell,
wherein the MAC CE causes the UE to consider a cell switch procedure to be ongoing, wherein the cell switch procedure is that a network triggers via the MAC CE based on a Layer 1 (L1) measurement, and wherein the cell switch procedure is where the UE skips a Random Access procedure.

40. A User Equipment (UE) comprising:
a memory; and
a processor coupled with the memory, wherein the processor is configured to:
receive, from a network, a cell switch command signalled via a Medium Access Control (MAC) Control Element (CE) on a serving cell, and
consider a cell switch procedure to be ongoing in a case where the UE receives the MAC CE, wherein the cell switch procedure is that the network triggers via the MAC CE based on a Layer 1 (L1) measurement, and wherein the cell switch procedure is where the UE skips a Random Access procedure.

41. A Radio Access Network (RAN) node comprising:
a memory; and
a processor coupled with the memory, wherein the processor is configured to:
send, to a User Equipment (UE), a cell switch command signalled via a Medium Access Control (MAC) Control Element (CE) on a serving cell,
wherein the MAC CE causes the UE to consider a cell switch procedure to be ongoing, wherein the cell switch procedure is that a network triggers via the MAC CE based on a Layer 1 (L1) measurement, and wherein the cell switch procedure is where the UE skips a Random Access procedure.
